(19) United States
(12) Patent Application Publication
(10) Pub. No.: US 2015/0124604 A1
(43) Pub. Date: May 7, 2015

(54) Systems and Methods for Proactive Congestion Detection in Radio Access Networks

(71) Applicant: Futurewei Technologies, Inc., Plano, TX (US)

(72) Inventors: Ngoc-Dung Dao, Ottawa (CA); Hang Zhang, Nepean (CA); Hamidreza Farmanbar, Ottawa (CA)

(21) Appl. No.: 14/516,459

(22) Filed: Oct. 16, 2014

Related U.S. Application Data
(60) Provisional application No. 61/900,812, filed on Nov. 6, 2013.

(51) Int. Cl. H04W 28/02

(52) U.S. Cl. CPC H04W 28/0289; H04W 28/0231
USPC 370/231

(57) ABSTRACT

System and method embodiments are provided for proactive congestion detection in radio access networks. In an embodiment, a method in a network component for inhibiting the occurrence of congestion at radio nodes in a network includes determining, by the network component, a congestion alert threshold according to available resources in the network, wherein the congestion alert threshold comprises an incoming data rate threshold to an ingress server; and transmitting, by the network component, the congestion alert threshold to the ingress server, wherein the ingress server is configured to transmit a congestion alert to the network component when the incoming data rate exceeds the congestion alert threshold.

### CROSS-REFERENCE TO RELATED APPLICATIONS

The present application claims the benefit of U.S. Provisional Patent Application No. 61/900,812 filed Nov. 6, 2013 and titled “System and Method for Proactive Congestion Detection in Radio Access Network,” which is incorporated herein by reference as if reproduced in its entirety.

### TECHNICAL FIELD

The present invention relates to a system and method for wireless communications, and, in particular embodiments, to a system and method for proactive congestion detection in a radio access network.

### BACKGROUND

In future wireless networks, including fifth generation (5G) mobile wireless networks, the density of radio access nodes could be much higher than that of the today networks. In this scenario, interference management plays an important role to improve the capacity of the networks. One of the interference management technologies is multi-node coordination, which regulates transmission parameters of multiple radio nodes such as transmit power of beam forming vectors. On the other hand, coordination of multiple radio nodes requires significant computing resources as well as signaling message exchange. Hence, reducing the coordination workload while maintaining a high performance is desired for practical 5G networks.

Multi-node coordination serves two purposes: (1) mitigate congestion at some radio nodes and (2) reduce system resource usage (energy and spectrum) in lightly loaded radio nodes. The duration of the first scenario could be on the order of a hundred milliseconds, but it may be long enough to cause loss and/or delay of important video frames, which significantly reduce the quality of experience (QoE) of video service as experienced by a user. Another possible situation for congestion to occur for a longer time scale of a few seconds is due to user movement and/or deep fades of wireless channels. Each scenario generally would require different solutions.

### SUMMARY

In an embodiment, a method in a network component for inhibiting the occurrence of congestion at radio nodes in a network includes determining, by the network component, a congestion alert threshold according to available resources in the network, wherein the congestion alert threshold comprises an incoming data rate threshold to an ingress server; and transmitting, by the network component, the congestion alert threshold to the ingress server, wherein the ingress server is configured to transmit a congestion alert to the network component when the incoming data rate exceeds the congestion alert threshold.

In an embodiment, a network component configured to proactively inhibit the occurrence of congestion at radio nodes in a network includes a processor; a receiver; a transmitter; and a computer readable storage medium storing programming for execution by the processor, the programming including instructions to: determine a congestion alert threshold according to available resources in the network, wherein the congestion alert threshold comprises an incoming data rate threshold to an ingress server; and cause the transmitter to transmit the congestion alert threshold to the ingress server, wherein the ingress server is configured to transmit a congestion alert to the network component when the incoming data rate exceeds the congestion alert threshold.

In an embodiment, a method in a network component for generating a potential congestion alarm includes receiving a congestion threshold from a proactive congestion detection server; monitoring a data rate from incoming traffic; generating a potential congestion alarm when the data rate exceeds the congestion threshold; and, transmitting the potential congestion alarm to the proactive congestion detection server.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a block diagram of an embodiment of a system for Proactive Congestion Detection (PCD) in SDN networks;

FIG. 2 is a block diagram of an embodiment of an ingress server;

FIG. 3 is a flowchart of an embodiment of a method in a PCD server for determining congestion alert thresholds;

FIG. 4 is a flowchart of an embodiment of a method for determining a congestion alert;

FIG. 5 is a flowchart of an embodiment of a method for changing traffic flow through the network in response to a congestion alert; and;

FIG. 6 is a block diagram of a processing system that may be used for implementing the devices and methods disclosed herein.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Most of the work in the area of congestion detection relies on user acknowledgement of TCP and its variants, where congestion is detected after the fact. The TCP end host (e.g., at the UE side) monitors the delay and packet loss. This detects congestion after it already has happened somewhere in the network. Fundamentally, the congestion is detected if the acknowledge message from end user equipment is not received by the sender after a certain window called round trip time (RTT). There are some major issues with this approach. First, congestion could be falsely detected in the downlink if there are transmission errors or congestion in the uplink. Second, packet loss due to retransmission errors at the radio nodes also may cause incorrect congestion detection.

An alternative to receiver-based congestion detection is to check the buffer status of network routing nodes. The routers can regularly check buffer status and declare congestion if the packets in the buffer are delayed above a threshold.

Recently, a framework for congestion control in software defined networks (SDNs) has been introduced. In this framework, the SDN controller, can collect traffic information from nodes in the network and adjust TCP parameters accordingly. This approach attempts to reduce the congestion after it has already occurred.

Disclosed herein are architectures, systems, and methods for proactively detecting impending congestion, potential congestion, or future congestion at radio nodes before the congestion occurs and altering network parameters to substantially reduce or mitigate adverse effects from network congestion.

An embodiment provides an architecture and methodology to detect congestion at radio nodes before it happens. An embodiment method may be referred to as proactive congestion detection (PCD), and may be incorporated in a software defined radio access network-radio control (SDRAN-RC) framework. Such PCD technology also may be used to prevent congestion in the time domain or geographical domain.

Congestion may be different for different types of traffic. For example, with real-time voice/audio with constant rate, congestion happens when the incoming rate to the network is larger than the outgoing rate, resulting in a packet drop rate larger than a threshold. However, for non-real-time video and audio with large buffer (few seconds) at the user's terminal, the fluctuation of outgoing rate may be significant. But as long as the average outgoing rate in a certain time window (of few seconds) is maintained, congestion alarm may be not triggered even when the instantaneous rate is higher than the threshold. A flow may be considered to be congested when its packets are not delivered within a delay bound.

An embodiment method detects congestion before it happens by monitoring short-term and medium-term incoming rates, traffic engineering (TE) rate allocation, radio node capacity, and spectral efficiency of the wireless link or a subset of these factors. While embodiment methods are described for radio nodes, the same principle can be applied to any type of network node. An embodiment allows a radio node coordinator to have enough time to optimize transmission parameters of radio nodes in advance. Consequently, congestion can be avoided before it happens.

The rate allocation from a centralized traffic engineering optimizer is used, together with radio resource information and up-to-date incoming rate monitoring, to predict possible congestion at radio nodes. Since congestion can be predicted beforehand, an embodiment can significantly improve quality of experience for delay-sensitive services like video. Embodiments may be implemented in network devices such as SDN routers and network controllers.

An embodiment enables high quality real-time communications services, such as real-time video conferencing. For real-time video traffic, the peak-to-mean ratio could be as high as 20. The high peak rate can cause short-term congestion. The peak rate is often associated with important video frames, which contain more information to decode other video frames. If important video frames are lost, dependent frames cannot be rendered properly decoding, and the whole video segment could be lost or decoded with poor quality. Therefore it is beneficial to predict short-term congestion at the radio node as early as possible, especially for real-time video flows.

With respect to PCD server functionality, an embodiment collects traffic engineering information, such as rate assignment to each flow, and monitors resource usage at the radio nodes. The incoming rate of flows is monitored: short-term (˜100 ms) and medium-term (˜500 ms). The embodiment collects and processes congestion alarms (also referred to as congestion alerts, potential congestion alerts, and potential congestion alarms) from an ingress server and/or other network routers. The rate threshold for each flow is computed so that the ingress server sends a congestion alarm once the incoming rate is higher than the threshold. In accordance with this information, the embodiment decides whether or not congestion could happen at radio nodes.

With respect to congestion detection methodology, each time the traffic engineering (TE) optimizer makes a decision, the PCD server calculates a threshold for a congestion alarm for each flow and sends it to the flow monitor at the ingress router, based on rate assignment from TE, spectral efficiency of the users' wireless links, and total bandwidth of the radio nodes. When the incoming rate is above the threshold, the flow monitor sends an alarm to the PCD server. The PCD server asks other flow monitors, which monitor flows running to the same radio nodes, to report the current flow data rate. In accordance with the up-to-date rate reports, the PCD server calculates the required bandwidth. Based on the required bandwidth and available bandwidth, a congestion condition can be declared.

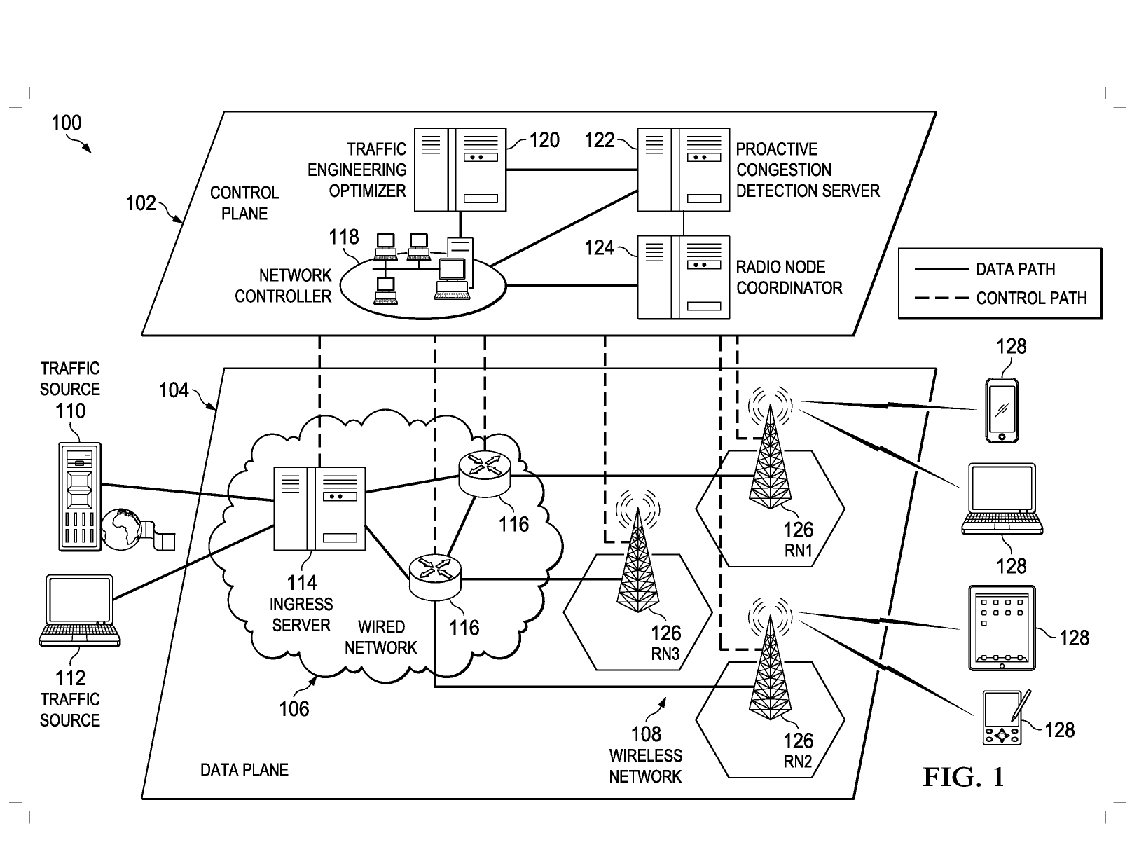

FIG. 1 is a block diagram of an embodiment of a system 100 for Proactive Congestion Detection (PCD) in SDN networks. System 100 includes a control plane 102 and a data plane 104. The control plane 102 includes a network controller 118, a traffic engineering optimizer 120, a PCD server 122, and a radio node coordinator 124. The data plane 104 includes a wired network 106 and a wireless network 108. Wired network 106 includes an ingress server 114 (also referred to as an ingress router) and a plurality of core routers 116. Wireless network 126 includes a plurality of radio nodes 126 (labeled RN1, RN2, and RN3). System 100 also includes traffic sources 110, 112 and user equipment (UEs) 128.

In an embodiment, the instantaneous data rate of flows are measured at the network nodes, such as ingress routers 114, core routers 116, which are as close to the traffic source 110, 112 as possible. The node that takes measurements sends a congestion alarm message to the PCD Server 122 whenever the data rate of a flow is above a threshold. The threshold is set for each flow as a function of the end-to-end bandwidth assigned to this flow. Note, in an embodiment, the end-to-end bandwidth of each flow is set by the traffic engineering optimizer 120.

In the above example, the congestion alarm message is sent to PCD server 122 only if the incoming rate of flow is above a threshold. Alternatively, the data rates of flows can be periodically measured by various network devices such as radio nodes and updates sent to PCD server 122 for live monitoring. This approach takes more network resources to send the rate reports regularly.

In particular, the incoming rates of flows can be monitored by a FlowMonitor in Ingress Server 114. Whenever the incoming rate of a flow is above a configurable threshold for this flow, a message containing the incoming rate of this flow is sent from the FlowMonitor to the PCD Server 122. The PCD Server 122 then requests that each of multiple Ingress Servers 114 measures incoming rates of other flows that run to the same radio node 126 and that run to neighboring radio nodes 126. The radio nodes 126 will also report the current spectral efficiency of all related flows. For each radio node 126, the required bandwidth Bₖ for a flow k is calculated as follows.

Bₖ=Rₖ/Sₖ

where Rₖ is the incoming rate measured at the ingress server and Sₖ is the spectral efficiency of radio channel of flow k. If the total required bandwidth of flows served by a radio node 126 is larger than its available bandwidth, a congestion event is declared.

In an embodiment, an alarm threshold is set by exploiting traffic diversity. One of the average rate, the effective rate, or the average rate in the last TE optimization period, is used to calculate the average resource usage at the radio nodes 126.

$${B}_{used} = {\sum }_{k} {B}_{k} = {\sum }_{k} {R}_{k} / {S}_{k}$$

Then the remaining resource Bᵣₑₘₐᵢₙ=Bₜₒₜₐₗ−B_{used} is used to calculate the threshold for each flow. For example, a flow k may be allowed to occupy the Bᵣₑₘₐᵢₙ bandwidth, which gives this flow an additional rate

R_{k,additional}=Bᵣₑₘₐᵢₙ×Sₖ

Hence the threshold of flow k for congestion alarm is R_{threshold}=Rₖ+R_{k,additional}.

There are several ways to deal with congestion at the radio nodes 126. Since it is desirable to maintain the high quality of services, in an embodiment, packet dropping is not considered an ideal response. Instead, other measures can be taken to exploit the traffic diversity and user diversity. Depending on the predicted data rates of flows, transmit parameters of radio nodes 126, such as transmit power, beam forming vectors, or number of carriers, are reconfigured.

This approach is fundamentally different from earlier methods which were based on the end-user TCP acknowledgement or the current buffer status at the radio nodes. In contrast to these earlier methods, according to the disclosed embodiment systems and methods, the radio node coordinator 124 has enough time to optimize transmission parameters of radio nodes 126 in advance. Consequently, congestion is avoided before it happens.

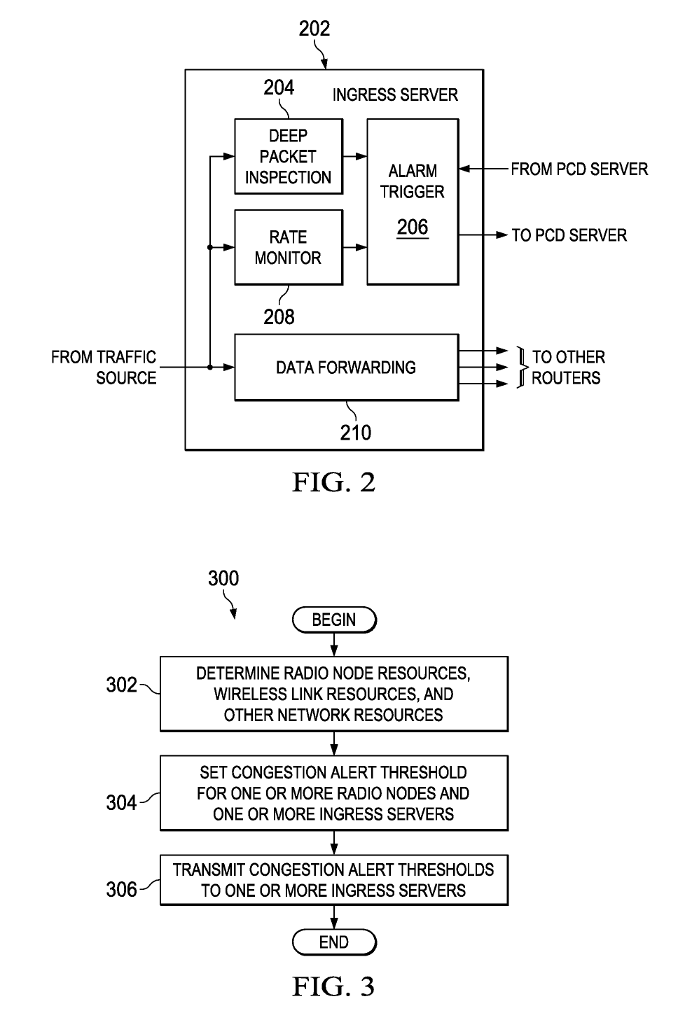

FIG. 2 is a block diagram of an embodiment of an ingress server 202. The ingress server 202 includes a deep packet inspection component 204, an alarm trigger 206, a rate monitor 208, and a data forwarding component 210. The ingress server 202 may be implemented as ingress server 114 in FIG. 1. The alarm trigger 206 receives congestion threshold value(s) from the PCD server. The ingress server 202 receives data from a traffic source (e.g., one of traffic sources 110, 112 in FIG. 1). The data forwarding component 210 forwards the data to other routers (e.g., routers 116 in FIG. 1) in the wired network (e.g., wired network 106 in FIG. 1). Data from the traffic source is also provided to the rate monitor 208 and the deep packet inspection component 204. The rate monitor 208 monitors the data rate of the data received from the traffic sources and provides this data rate to the alarm trigger 206. The alarm trigger 206 transmits a congestion alarm to the PCD server (e.g., PCD server 122 in FIG. 1) if the data rate measured by the rate monitor exceeds a threshold that had been received by the alarm trigger 206 from the PCD server. In an embodiment, the threshold is dynamically determined by the PCD server based on various network factors, such as wireless link capacity, available resources (such as, for example, available transmission rate) of radio nodes, and rate allocation from a traffic engineering optimizer.

In some embodiments, the congestion alarm sent out depends on the importance of the packet content. For example, with deep packet inspection of received data by deep packet inspection component 204, it is possible to identify that the high rate is due to important video frames (e.g., an I-frame in an MPEG video stream) or less important frame (e.g., P or B-frame). In the case of less important video frames, the congestion alarm may not be sent out by alarm trigger 206. If congestion later happens at radio nodes (e.g., radio nodes 126 in FIG. 1), the radio nodes can drop the less important packets. In an embodiment, the alarm trigger sends the congestion alarm to the PCD server (e.g., PCD server 122 in FIG. 1) together with the type of data content. The PCD server decides how to further process the alarm message.

In an embodiment, congestion is predicted with a false probability. To reduce the number of false alarms, the buffer status or current resource utilization of the radio nodes is exploited. For example, if the current resource utilization is low, radio nodes take more data to transmit. This will help to reduce the delay of future packets. Hence, the congestion probability is reduced. Thus, in an embodiment, a correction factor is added to the function that declares congestion at the PCD server.

FIG. 3 is a flowchart of an embodiment of a method 300 in a PCD server for determining congestion alert thresholds. The method 300 may be implemented in a PCD server, such as, for example, PCD server 122 in FIG. 1. The method 300 begins at block 302 where the PCD server determines resource information including the radio node resources, wireless link resources, and/or other network resources. The PCD server may receive some or all of the resource information from a radio node coordinator. In an embodiment, the PCD server may receive some or all of the resource information from a traffic engineering optimizer and/or a network controller. The resource information may include the transmit power of each radio node, the number of UEs served by each radio node, the type of data (e.g., video streams, voice data, etc.) currently being served by the radio nodes, etc. At block 304, the PCD server sets the congestion alert threshold for one or more radio nodes and/or one or more ingress servers according to the resource information. The thresholds are set such that a congestion alert will be triggered before congestion occurs at the radio nodes, thereby allowing the traffic engineering and data rates to be adjusted to prevent or mitigate potential congestion. The congestion alert thresholds may be different for different ingress servers and/or for different radio nodes. The congestion alert thresholds may also be different for different types of network traffic (e.g., video, audio, etc.) or even different types of a specific data type (e.g., different types of video that distinguish more important video data from less important video data). At block 306, the PCD server transmits the congestion alert thresholds to one or more ingress servers, after which, the method 300 ends. In some embodiments, the PCD server receives and monitors the resource information and updates the thresholds frequently. In other embodiments, the PCD server receives and monitors the resource information and updates the thresholds infrequently or only in response to a substantial change to the network conditions, such as, for example, a loss of one of the radio nodes or a change in transmit power or data throughput through a radio network that exceeds a boundary. In an embodiment, the method 300 is stored as computer executable instructions on a computer readable media and executed by one or more processors.

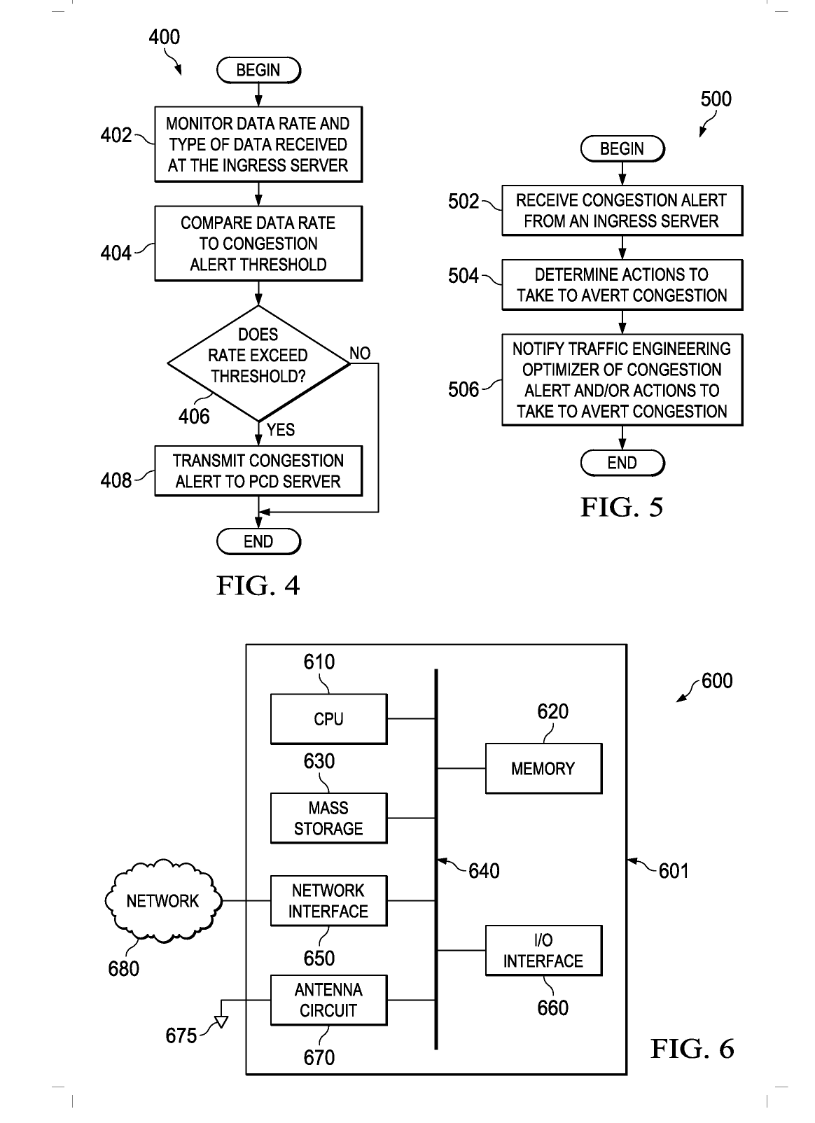

FIG. 4 is a flowchart of an embodiment of a method 400 for determining a congestion alert. The method 400 may be implemented in an ingress server, such as, for example, ingress server 114 in FIG. 1. The method 400 begins at block 402 where the ingress server monitors data rates and, in some embodiments, the type of data, received at the ingress server from traffic sources. At block 404, the ingress server compares the data rate to the congestion alert threshold. At block 406, the ingress server determines whether the data rate exceeds the threshold. If the data rate does not exceed the threshold, no congestion alert is generated and the method 400 ends. If the data rate does exceed the threshold, the method 400 proceeds to block 408 where the ingress server generates a congestion alert and transmits the congestion alert to the PCD server, after which, the method 400 ends. The congestion alert message may include information indicating by how much the data rate exceeds the threshold and the type of and/or source of the data traffic. In an embodiment, the congestion alert message includes the identity of the source of the traffic causing the congestion alert when there are different sources of traffic. The congestion alert may also include other information depending on the embodiment. In an embodiment, the method 400 is stored as computer executable instructions on a computer readable media and executed by one or more processors.

FIG. 5 is a flowchart of an embodiment of a method 500 for changing traffic flow through the network in response to a congestion alert. The method 500 may be implemented in a PCD server, such as, for example, PCD server 122 in FIG. 1. The method 500 begins at block 502 where the PCD server receives a congestion alert from an ingress server. At block 504, the PCD server determines actions to take to avert the congestion. Examples of actions that could be taken include changing the flow of traffic through the network, reducing a data rate at various points in the network, etc. At block 506, the PCD server notifies the traffic engineering optimizer of the congestion alert and/or actions to take to avert congestion, after which, the method 500 ends. In an embodiment, rather than determining the actions to take to avert congestion, the PCD server notifies the traffic engineering optimizer of the congestion alert, the location from which the alert was received, the type of traffic causing the congestion alert, a time stamp, and/or the data rate of incoming traffic causing the congestion alert and the traffic engineering optimizer determines actions to take to avert or minimize congestion at the radio nodes. In an embodiment, the PCD server notifies the traffic engineering optimizer of the identity of the ingress server issuing the congestion alert. In an embodiment, the method 500 is stored as computer executable instructions on a computer readable media and executed by one or more processors.

FIG. 6 is a block diagram of a processing system 600 that may be used for implementing the devices and methods disclosed herein. Specific devices may utilize all of the components shown, or only a subset of the components and levels of integration may vary from device to device. Furthermore, a device may contain multiple instances of a component, such as multiple processing units, processors, memories, transmitters, receivers, etc. The processing system 600 may comprise a processing unit 601 equipped with one or more input/output devices, such as a speaker, microphone, mouse, touchscreen, keypad, keyboard, printer, display, and the like. The processing unit 601 may include a central processing unit (CPU) 610, memory 620, a mass storage device 630, a network interface 650, an I/O interface 660, and an antenna circuit 670 connected to a bus 640. The processing unit 601 also includes an antenna element 675 connected to the antenna circuit.

The bus 640 may be one or more of any type of several bus architectures including a memory bus or memory controller, a peripheral bus, video bus, or the like. The CPU 610 may comprise any type of electronic data processor. The memory 620 may comprise any type of system memory such as static random access memory (SRAM), dynamic random access memory (DRAM), synchronous DRAM (SDRAM), read-only memory (ROM), a combination thereof, or the like. In an embodiment, the memory 620 may include ROM for use at boot-up, and DRAM for program and data storage for use while executing programs.

The mass storage device 630 may comprise any type of storage device configured to store data, programs, and other information and to make the data, programs, and other information accessible via the bus 640. The mass storage device 630 may comprise, for example, one or more of a solid state drive, hard disk drive, a magnetic disk drive, an optical disk drive, or the like.

The I/O interface 660 may provide interfaces to couple external input and output devices to the processing unit 601. The I/O interface 660 may include a video adapter. Examples of input and output devices may include a display coupled to the video adapter and a mouse/keyboard/printer coupled to the I/O interface. Other devices may be coupled to the processing unit 601 and additional or fewer interface cards may be utilized. For example, a serial interface such as Universal Serial Bus (USB) (not shown) may be used to provide an interface for a printer.

The antenna circuit 670 and antenna element 675 may allow the processing unit 601 to communicate with remote units via a network. In an embodiment, the antenna circuit 670 and antenna element 675 provide access to a wireless wide area network (WAN) and/or to a cellular network, such as Long Term Evolution (LTE), Code Division Multiple Access (CDMA), Wideband CDMA (WCDMA), and Global System for Mobile Communications (GSM) networks. In some embodiments, the antenna circuit 670 and antenna element 675 may also provide Bluetooth and/or WiFi connection to other devices.

The processing unit 601 may also include one or more network interfaces 650, which may comprise wired links, such as an Ethernet cable or the like, and/or wireless links to access nodes or different networks. The network interface 601 allows the processing unit 601 to communicate with remote units via the networks 680. For example, the network interface 650 may provide wireless communication via one or more transmitters/transmit antennas and one or more receivers/receive antennas. In an embodiment, the processing unit 601 is coupled to a local-area network or a wide-area network for data processing and communications with remote devices, such as other processing units, the Internet, remote storage facilities, or the like.

The following references are related to subject matter of the present application. Each of these references is incorporated herein by reference in its entirety:
[1] C. Y. Wan, S. B. Eisenman, A. T. Campbell, CODA: Congestion detection and avoidance in sensor networks, in: Proc. of the ACM Conf. on Embedded Networked Sensor Systems (SenSys), Los Angeles, Calif., November 2003.
[2] Balakrishnan, H.; Padmanabhan, V. N.; Seshan, S.; Katz, R. H., “A comparison of mechanisms for improving TCP performance over wireless links,” IEEE/ACM Transactions on Networking, vol. 5, no. 6, pp. 756,769, December 1997.
[3] S. Floyd and V. Jacobson, Random Early Detection Gateways for Congestion Avoidance, EEEiACM Transactions on Networking, vol. 1, August 1993.
[4] M. Ghobadi, S. H. Yeganeh, and Y. Ganjali. Rethinking End-to-End Congestion Control in Software-Defined Networks. In HotNets '12.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method in a network component for inhibiting an occurrence of congestion at radio nodes in a network, the method comprising:
determining, by the network component, a congestion alert threshold according to available resources in the network, wherein the congestion alert threshold comprises an incoming data rate threshold to an ingress server; and
transmitting, by the network component, the congestion alert threshold to the ingress server, wherein the ingress server is configured to transmit a congestion alert to the network component when the incoming data rate exceeds the congestion alert threshold.

2. The method of claim 1, further comprising receiving the congestion alert from the ingress server.

3. The method of claim 2, further comprising determining actions to inhibit future congestion according to the congestion alert.

4. The method of claim 3, wherein the actions comprise redirecting traffic through the network.

5. The method of claim 2, further comprising transmitting, in response to receiving the congestion alert, an traffic reengineering alert to a traffic engineering optimizer to reengineer traffic to avoid future congestion.

6. The method of claim 5, wherein the alert comprises information regarding at least one of a type of network traffic causing the congestion alert, a time stamp, an identity of ingress server issuing the congestion alert, a data rate of incoming traffic to the ingress server, and an available transmission rate of at least one radio node.

7. The method of claim 1, further comprising dynamically modifying the congestion alert threshold according to changes in conditions in the network.

8. The method of claim 7, further comprising receiving periodic updates in network conditions from at least one network device.

9. The method of claim 7, further comprising receiving updates in network conditions from a network device when the network device detects a change in network conditions.

10. The method of claim 1, wherein the congestion alert threshold is indicative of congestion at a node other than the network component and the ingress server.

11. The method of claim 10, wherein the node other than the network component and the ingress server is a radio node.

12. The method of claim 1, wherein the threshold is associated with a cumulative data rate of flows through a radio node.

13. A network component configured to proactively inhibit an occurrence of congestion at radio nodes in a network, comprising:
a processor;
a receiver;
a transmitter; and
a computer readable storage medium storing programming for execution by the processor, the programming including instructions to:
determine a congestion alert threshold according to available resources in the network, wherein the congestion alert threshold comprises an incoming data rate threshold to an ingress server; and
cause the transmitter to transmit the congestion alert threshold to the ingress server, wherein the ingress server is configured to transmit a congestion alert to the network component when the incoming data rate exceeds the congestion alert threshold.

14. The network component of claim 13, wherein the programming further comprises instructions to receive the congestion alert from the ingress server.

15. The network component of claim 14, wherein the programming further comprises instructions to determine actions to inhibit future congestion according to the congestion alert.

16. The network component of claim 15, wherein the actions comprise redirecting traffic through the network.

17. The network component of claim 14, wherein the programming further comprises instructions to transmit, in response to receiving the congestion alert, a traffic reengineering alert to a traffic engineering optimizer to reengineer traffic to avoid future congestion.

18. The network component of claim 17, wherein the alert comprises information regarding at least one of a type of network traffic causing the congestion alert, a time stamp, an identity of ingress server issuing the congestion alert, a data rate of incoming traffic to the ingress server, and an available transmission rate of at least one radio node.

19. The network component of claim 13, wherein the programming further comprises instructions to dynamically modify the congestion alert threshold according to changes in conditions in the network.

20. The network component of claim 19, wherein the programming further comprises instructions to receive periodic updates in network conditions from at least one network device.

21. The network component of claim 19, wherein the programming further comprises instructions to receive updates in network conditions from a network device when the network device detects a change in network conditions.

22. A method in a network component for generating a potential congestion alarm, the method comprising:
receiving a congestion threshold from a proactive congestion detection server;
monitoring a data rate from incoming traffic;
generating a potential congestion alarm when the data rate exceeds the congestion threshold; and,
transmitting the potential congestion alarm to the proactive congestion detection server.

23. The method of claim 22, further comprising performing deep packet inspection on received data to determine a type of data of the incoming traffic.

24. The method of claim 22, wherein the congestion threshold comprises a plurality of congestion thresholds with different thresholds for at least one of different types of traffic and different sources of traffic.

25. The method of claim 22, wherein the congestion threshold is associated with data flows directed to a radio node.
